(19) United States
(12) Patent Application Publication
(10) Pub. No.: US 2017/0004647 A1
(43) Pub. Date: Jan. 5, 2017

(54) RENDERING GRAPHICS DATA ON DEMAND

(71) Applicant: Microsoft Technology Licensing, LLC, Redmond, WA (US)

(72) Inventor: Mark Grossman, Palo Alto, CA (US)

(21) Appl. No.: 14/755,381

(22) Filed: Jun. 30, 2015

(51) Int. Cl. G06T 15/00; G06T 1/60

(52) U.S. Cl. CPC G06T 15/005; G06T 1/60

(57) ABSTRACT

Methods and systems for rendering graphics data on demand are described herein. One or more page tables are stored that map virtual memory addresses to physical memory addresses and task IDs. A page fault is experienced when a task running on a GPU accesses, using a virtual memory address, a page of memory that has not been written to by the GPU. Context switching is performed in response to the page fault, which frees up the GPU. GPU threads are identified and executed in dependence on the task ID associated with the virtual memory address being used when the page fault occurred to thereby cause the GPU to write to the page of memory associated with the page fault. Further context switching is performed to retrieve and return the state of the task that was running on the GPU when the page fault occurred, and the task is resumed.

### BACKGROUND

Three-dimensional (3D) computer graphics systems, which can render objects from a 3D world (real or imaginary) onto a two-dimensional (2D) display screen, are currently used in a wide variety of applications. For example, 3D computer graphics can be used for real-time interactive applications, such as video games, virtual reality, scientific research, etc., as well as off-line applications, such as the creation of high resolution movies, graphic art, etc.

### SUMMARY

Embodiments described herein relate to methods and systems for rendering graphics data on demand. Such systems include a graphics processing unit (GPU), and such methods are for use with a system including a GPU. In accordance with an embodiment, one or more page tables are stored that map virtual memory addresses to physical memory addresses and task identifiers (task IDs). A page fault is experienced in response to a task running on the GPU accessing, using a virtual memory address, a page of memory that has not been written to by the GPU. Context switching is performed in response to the page fault, which frees up the GPU. One or more GPU threads are identified and executed in dependence on the task ID associated with the virtual memory address being used when the page fault occurred to thereby cause the GPU to write to the page of memory associated with the page fault. Further context switching is performed to retrieve and return the state of the task that was running on the GPU when the page fault occurred. The task running on the GPU when the page fault occurred is then resumed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an exemplary computer system with which embodiments of the present technology can be implemented.

FIG. 2 is a high level flow diagram that is used to describe methods for rendering graphics data on demand in accordance with certain embodiments of the present technology.

FIG. 3 is a high level flow diagram that is used to describe additional details of one of the steps introduced in FIG. 2 in accordance with certain embodiments of the present technology.

FIG. 4 is a high level flow diagram that is used to describe additional details of another one of the steps introduced in FIG. 2 in accordance with certain embodiments of the present technology.

FIG. 5 illustrates an exemplary look-up-table (LUT) that maps task IDs to shader program addresses and command buffer addresses that can be used, in accordance with certain embodiments of the present technology, to write to a page of memory associated with a page fault to render graphics data on demand. The LUT in FIG. 5 also maps task IDs to numbers of GPU threads to be executed during a common time interval to resolve page faults, and more specifically, render graphics data on demand.

FIG. 6 illustrates an exemplary look-up-table (LUT) that maps task IDs to shader program addresses and command buffer addresses that can be used, in accordance with certain embodiments of the present technology, to write to a page of memory associated with a page fault to render graphics data on demand. The LUT in FIG. 5 also maps task IDs to algorithms used to determine numbers of GPU threads to be executed during a common time interval to resolve page faults, and more specifically, render graphics data on demand.

### DETAILED DESCRIPTION

Typically, a graphics system includes a graphics processing unit (GPU). A GPU may be implemented as a co-processor component to a central processing unit (CPU) of a computer system, and may be provided in the form of an add-in card (e.g., video card), co-processor, or as functionality that is integrated directly into the motherboard of the computer or into other devices, such as a gaming device. Typically, the GPU has a “graphics pipeline,” which may accept as input some representation of a 3D scene and output a 2D image for display. OpenGL® Application Programming Interface (API) and Direct3D® API are two example APIs that have graphic pipeline models. In 3D computer graphics, the graphics pipeline (also known as the rendering pipeline) refers to the sequence of steps used to create a 2D raster representation of a 3D scene. In other words, once a 3D model has been created, e.g., in a video game or other 3D computer animation, the graphics pipeline is the process of turning that 3D model into what the computer system displays. Conventionally, where there is a need or desire to render graphics in real time, or near real time (e.g., for use in a video game), it is typically necessary to pre-render dynamic content at a needed level of detail determined by a pre-pass or approximation (e.g., shadow map, procedural textures, and/or terrain maps). However, such pre-rendering of graphics is not always practical, and is often an inefficient use of system resources. Certain embodiments of the present technology, which are described below, relate to methods and systems for rendering graphics data on demand. Such embodiments may alleviate that need for, or at least reduce the extent of, pre-rendering of graphics.

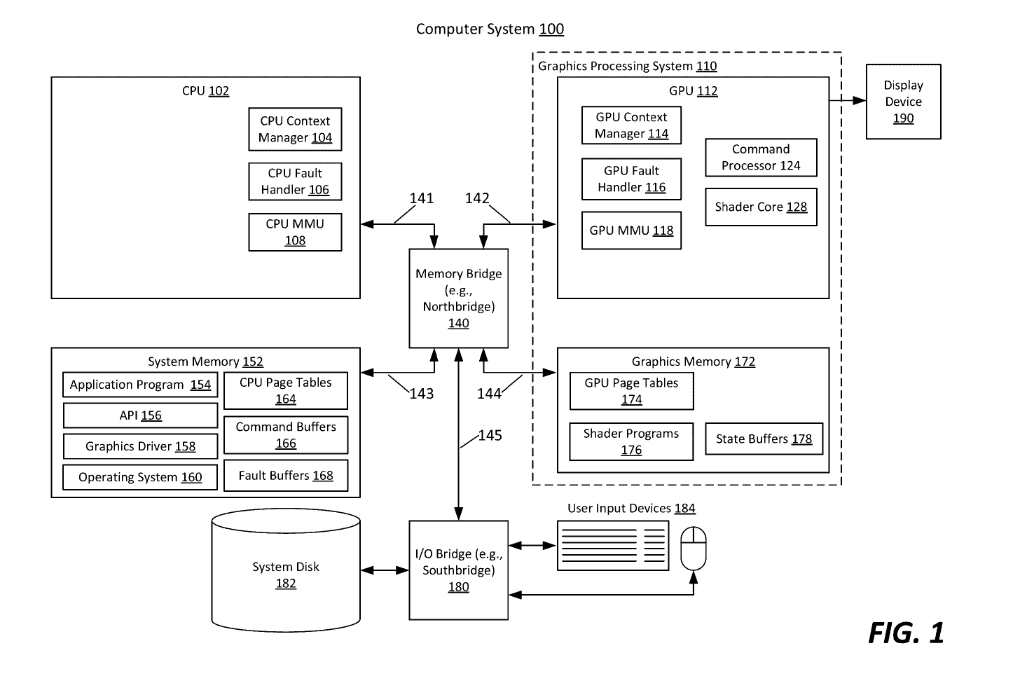

FIG. 1 is a block diagram illustrating an exemplary computer system 100 with which embodiments of the present technology can be implemented. The computer system 100 is shown as including a central processing unit (CPU) 102, a graphics processing unit (GPU) 112, a memory bridge 140, system memory 152, graphics memory 172, an input/output (I/O) bridge 180, a system disk 182, user input devices 184 and a display device 190. The GPU 112 and the graphics memory 172 are shown as being parts of a graphics processing system 110.

The CPU 102 can execute the overall structure of a software application and can configure the GPU 112 to perform specific rendering and/or compute tasks in the graphics pipeline (the collection of processing steps performed to transform 3-D images into 2-D images). Depending upon implementation, the GPU 112 may be capable of very high performance using a relatively large number of small, parallel execution threads on dedicated programmable hardware processing units.

The CPU 102, the GPU 112, the system memory 152, and the graphics memory 172 are shown as being coupled to the memory bridge 140, by respective communication paths 141, 142, 143, and 144, one or more of which can be a bus. The memory bridge 140, which may be, e.g., a Northbridge chip, is also coupled via a bus or other communication path 145 (e.g., a HyperTransport link) to an input/output (I/O) bridge 180. I/O bridge 180, which may be, e.g., a Southbridge chip, receives user inputs from one or more user input devices 184 (e.g., keyboard, mouse, touchpad, trackball, camera capture device, etc.) and forwards the user inputs to the CPU 102 via the memory bridge 140. The communication path 142 between the GPU 112 and the memory bridge 140 can be, e.g., a Peripheral Component Interconnect Express (PCIe) or HyperTransport link, but is not limited thereto. The system disk 182 is also connected to I/O bridge 180 and may be configured to store content and applications and data for use by the CPU 102 and/or the GPU 112. The system disk 182 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. The storage capacity of the system disk 182 it typically significantly larger than the storage capacity of the system memory 152 and the graphics memory 172. However, there is a latency associated with CPU 102 or GPU 112 accessing the system disk 182, which is typically much longer than any latency associated with accessing the system memory 152 or the graphics memory 172.

The CPU 102 is shown as including, by virtue of including hardware components and/or executing special purpose software components as appropriate, a CPU context manager 104, a CPU fault handler 106 and a CPU memory management unit (MMU) 108. The GPU 112 is shown as including, by virtue of including hardware components and/or executing special purpose software components as appropriate, a GPU context manger 114, a GPU fault handler 116 and a GPU memory management unit (MMU). The GPU 112 is also shown as including a command processor 124 and a shader core 128. One of ordinary skill in the art would appreciate that the CPU 102 and the GPU 112 can include additional elements or components not specifically shown in FIG. 1 or discussed herein for brevity.

The GPU context manager 114 is responsible for performing context switching when appropriate. Context switching can involve saving the virtual memory address being used when a page fault occurred. Context switching can also involve storing GPU state information associated with a state of a task in response to an interrupt, so that execution of the interrupted task can be resumed from the same point at a later time. One type of interrupt that may trigger context switching is a page fault. As described in additional detail below, the CPU MMU 108 and/or the GPU MMU 118 may experience a page fault when a task running on the CPU 102 or GPU 112 accesses a page of memory located at a physical address that has not been written to by the CPU 102 or the GPU 112 respectively. It should be noted that page faults may alternatively occur due to a read or write permission violation. However, in the context of the embodiments of the present technology described herein, a “page fault” refers to an invalid page fault, where the contents of a page are not up to date. In other words, the term “page fault”, as used herein, refers to an invalid page fault. In response to the GPU 112 experiencing a page fault, the GPU MMU 118 can interrupt the GPU context manager 114, to initiate handling the page fault and to inform the GPU fault handler 116 or the CPU fault handler 106 of the page fault, and more specifically, of a virtual memory address that was being used when the page fault occurred. The GPU context manager 114 can be implemented using software, hardware, firmware, or a combination thereof. The GPU context manager 114 may have access to hardware registers in which virtual memory addresses and/or state information can be saved.

When informed of a page fault, the GPU context manager 114 can store the virtual address that caused the page fault in one of the fault buffers 168, which is/are shown as being within the system memory 152, but can alternatively or additionally be within the graphics memory 172. Additionally, the GPU context manager 114 can store state information, associated with the state of the task that was running when the page fault occurred, in one of the state buffers 178 or in a portion of the system memory 152 that is dedicated to storing such state information. The state information, can include, for example, data in GPU registers and in a program counter at a specific point in time while the task is being performed. The saving of such state information enables the state of the task to be returned, at a later time, to the same state at which it was interrupted. The saving of the virtual address that caused the page fault enables the task that was running when the page fault was experienced, to again request a translation of the virtual address, after the reason for the page fault has been resolved, and thus, for the task to be resumed. In other words, the saving of the virtual address enables the task to resume, at a later time, at the same point at which it was interrupted. Further, in accordance with certain embodiments of the present technology described herein, the saving of the virtual address enables identification of a task, associated with the saved virtual address, which is to be executed in order to produce the contents of the invalid page.

The CPU MMU 108 can receive requests for translations of virtual memory addresses from a program running on the CPU 102, and provides a translation from the CPU page tables 164 for each of the virtual memory addresses it issues. To perform such translations, the CPU MMU 108 can utilize the CPU page tables 164, which includes mappings of virtual memory addresses to physical memory addresses. More specifically, in certain embodiments each of the CPU page tables 164 includes a plurality of page table entries (PTEs), wherein each of the PTEs includes a physical memory address to which a virtual memory address is mapped and a valid bit. The valid bit associated with each of the PTEs is either set to 1 or set to 0. When a valid bit is set to 1, the valid bit indicates that contents of a page of memory located at the physical address of the PTE has been written to by the CPU or GPU. When a valid bit is set to 0, the valid bit indicates that contents of a page of memory located at the physical address of the PTE has not been written to by the CPU or GPU. The CPU MMU 108 will experience a page fault when it accesses a page of memory for which the valid bit, in the PTE corresponding to the page of memory, is set to 0. For example, the CPU MMU 108 will experience a page fault when the contents of a page of memory (also known as a memory page) that is accessed has not been filled with valid data from swap space on the system disk 182. For a more specific example, a page fault can occur when a running program accesses a memory page that is mapped into a virtual address space, but not loaded in physical memory. The CPU MMU 108 is most likely implemented in hardware, as is well known in the art. It would also be possible for at least certain aspects of the CPU MMU 108 to be implemented using firmware and/or software.

The CPU fault handler 106 executes steps in response to the CPU MMU 108 generating a page fault, to make requested data available to the CPU 102 and/or GPU 112. Conventionally, the CPU fault handler 106 may respond to a page fault by reading appropriate data, from the system disk 182, and writing the data to physical memory, so that it is thereafter available to be accessed by the faulting CPU program via the CPU MMU 108. The CPU fault handler 106 can be software that resides in the system memory 152 and executes on the CPU 102, the software being provoked by an interrupt to the CPU 102. For example, the CPU fault handler 106 can be an operating system routine.

The system memory 152 is shown as storing one or more application programs 154, an application program interface (API) 156, a graphics driver 158, and an operating system 160, which are all executed by the CPU 102. The operating system 160, which is typically the master control program of the computer system 100, can manage the resources of the computer system 100, such as the system memory 152, and forms a software platform on top of which the application program(s) 154 may run. The application program(s) 154 may generate calls to the API 156 in order to produce desired results, e.g., in the form of graphics images. The application program(s) 154 may also transmit one or more high level shading programs to the API 156 for processing within the graphics driver 158. The high level shading programs can be source code text of high level programming instructions that are designed to operate on components within the graphics processing system 110. The API 156 functionality is typically implemented within the graphics driver 158. The graphics driver 158 can translate the high level shading programs into machine code shading programs that execute on components within the graphics processing system 110.

The graphics processing system 110 executes commands transmitted by the graphics driver 158 in order to render graphics data and images. Subsequently, the graphics processing system 110 may display certain graphics images on a display device 190 that is connected to the graphics processing system 110, e.g., via a video cable. The display device 190 is an output device capable of displaying a visual image corresponding to an input graphics image. For example, the display device 190 may be built using a liquid crystal display (LCD), a cathode ray tube (CRT) monitor, or any other suitable display system. While only one display device 190 is shown in FIG. 1, the computer system 100 can alternatively include multiple display devices 190, which can be the same as or different than one another.

The GPU 112 is used to render two-dimensional (2-D) and/or three-dimensional (3-D) images for various applications such as video games, graphics, computer-aided design (CAD), simulation and visualization tools, imaging, etc. The GPU 112 may perform various graphics operations such as transformation, rasterization, shading, blending, etc. to render a 3-D image. A 3-D image may be modeled with surfaces, and each surface may be approximated with primitives. Primitives are basic geometry units and may include triangles, lines, other polygons, etc. Each primitive can be defined by one or more vertices e.g., three vertices for a triangle. Each vertex can be associated with various attributes such as space coordinates, color, texture coordinates, etc. Each attribute may include one or more components. For example, space coordinates may be given by either three components x, y and z or four components x, y, z and w, where x and y are horizontal and vertical coordinates, z is depth, and w is a homogeneous coordinate. Color may be given by three components r, g and b or four components r, g, b and a, where r is red, g is green, b is blue, and a is a transparency factor that determines the transparency of a pixel. Texture coordinates are typically given by horizontal and vertical coordinates, u and v. A vertex may also be associated with other attributes. In accordance with specific embodiments, commands, shader instructions, textures, and other data, which are stored in the graphics memory 172 and/or the system memory 152, are accessed by the GPU 112 using virtual addresses assigned to specific GPU tasks.

The system memory 152 is also show as including CPU page table(s) 164, command buffers 166 and fault buffers 168. As noted above, the CPU page table(s) 164 include mappings between virtual memory addresses and physical memory addresses. The command buffers 166, which can also be referred to as a command queue, store commands that are to be executed by the GPU 112. For example, the CPU 102 can store instructions, based on application programs 154, in appropriate command buffers 166. The fault buffers 168 can store one or more virtual address that caused a page fault, as will be described in additional detail below.

The GPU 112 is shown as including a GPU context manager 114, a GPU fault handler 116 and a GPU memory management unit (MMU) 118, as noted above. The GPU 112 is also shown as including a command processor 124 and a shader core 128. The GPU context manager 114 is responsible for performing context switching when appropriate, such as in response to a page fault experienced by the GPU MMU 118 when a task running on the GPU 112 accesses a page of memory located at a physical address that has not been written to by the GPU 112. When informed of a page fault, the GPU context manager 114 can store the virtual address that caused the page fault in one of the fault buffers 168, which is shown as being within the system memory 152, but can alternatively or additionally be within the graphics memory 172. Additionally, the GPU context manager 114 can store state information associated with the state of the task that was running when the page fault occurred in one or more state buffers 178 residing in a portion of the graphics memory 172 (or potentially the system memory 152) that is dedicated to storing such state information. While the computer system 100 is shown as including both a CPU context manger 104 and a GPU context manager 114, the computer system 100 can alternatively include only one type of context manager that performs all context switching for the computer system 100.

The GPU MMU 118 can receive requests for translations of virtual memory addresses from the GPU 112, and can perform translations of the virtual memory addresses. To perform such translations, the GPU MMU 118 can utilize the GPU page table(s) 174, which includes mappings of virtual memory addresses to physical memory addresses. More specifically, each of the GPU page tables 174 includes a plurality of page table entries (PTEs), wherein each of the PTEs includes a physical memory address to which a virtual memory address is mapped and a valid bit. The valid bit associated with each of the PTEs is either set to 1 or set to 0. When a valid bit is set to 1, the valid bit indicates that contents of a page of memory located at the physical address of the PTE has been written to by the GPU 112, or potentially by the CPU 102. When a valid bit is set to 0, the valid bit indicates that contents of a page of memory located at the physical address of the PTE has not been written to by the CPU or GPU. The GPU MMU 118 can experience a page fault when it accesses a page of memory for which the valid bit, in the PTE corresponding to the page of memory, is set to 0. In other words, the GPU MMU 118 can experience a page fault when a page of memory that is accessed has not been written to by the GPU 112. For a more specific example, a page fault can occur when a running GPU task (i.e., a task running on the GPU 112) accesses a memory page that is mapped into a virtual address space, but not loaded in physical memory. Each GPU task can include, among other things, one or more shader programs, one or more command buffers, state information, configuration information, virtual address space information, and/or the like, depending upon implementation. In specific embodiments, the one or more shader programs are accessed via a shader program address, and the one or more command buffers are accessed via a command buffer address. Other embodiments involve a list of addresses for each. In accordance with specific embodiments, the shader programs include instructions executed by one or more simultaneous threads of execution on the GPU. The GPU MMU 118 can be implemented in hardware. It would also be possible for at least certain aspects of the CPU MMU 108 to be implemented using firmware and/or software.

In accordance with specific embodiments of the present technology, the GPU fault handler 116 executes steps in response to the GPU MMU 118 generating a page fault, to make requested data available to the GPU 112. Conventionally, the a computer system may respond to a page fault by reading appropriate data, from the system disk 182, and writing the data to physical memory, so that it is thereafter available to be accessed by the GPU MMU 118. However, such conventional handing of page faults experience latency, which can be referred to as disk latency, associated with the system disk 182 being accessed. While show as being part of the GPU 102, the GPU fault handler 116 can be software that resides in the graphics memory 172 and executes on the GPU 112, the software being provoked by an interrupt to the GPU 112. It would also be possible to implement at least a portion of the GPU fault handler 116 in hardware and/or firmware.

The command processor 124 can control processing within the GPU 112. The command processor 124 can also retrieve instructions to be executed from the command buffers 166 in the system memory 152 and can coordinate the execution of those instructions on the GPU 112. For an example, the CPU 102 may store commands and related data based on application programs 154 in appropriate command buffers 166. A plurality of command buffers 166 can be maintained with each process scheduled for execution on the GPU 112 having its own command buffer 166. The command processor 124 can be implemented in hardware, firmware, or software, or a combination thereof. In one embodiment, command processor 124 is implemented as a RISC engine with microcode for implementing logic including scheduling logic. In accordance with an embodiment, the command processor 124 can initiate threads in the shader core 128.

The GPU 112 can include its own compute units (not shown), such as, but not limited to, one or more single instruction multiple data (SIMD) processing cores. As referred to herein, a SIMD is a pipeline, or programming model, where a kernel is executed concurrently on multiple processing elements each with its own data and a shared program counter. In one example, each compute unit of the GPU 112 can include one or more scalar and/or vector floating-point units and/or arithmetic and logic units (ALUs). It is also possible that certain compute units of the GPU 112 are special purpose processing units (not shown), such as inverse-square root units and sine/cosine units. The compute units of the GPU 112 are referred to herein collectively as the shader core 128.

The shader core 128 can be used to execute shader programs 176, which are shown as being stored in the graphics memory 172. The shader programs 176 are programs that are coded for the GPU 112 and can be used to render effects. For example, the position, hue, saturation, brightness, and contrast of all pixels, vertices, or textures used to construct a final image can be altered on the fly, using algorithms defined in the shader programs 176, and can be modified by external variables or textures introduced by the shader programs 176. Exemplary types of shader programs include, but are not limited to, pixel shaders, 3D shaders, vertex shaders, geometry shaders and tessellation shaders. Pixel shaders, which also known as fragment shaders, can compute color and other attributes of individual pixels. 3D shaders act on 3D models or other geometry but may also access the colors and textures used to draw a model or mesh. Vertex shaders are a type of 3D shader, generally modifying on a per-vertex basis. Vertex shaders can transform each vertex's 3D position in virtual space to the 2D coordinate at which it appears on a screen (as well as a depth value for the Z-buffer). Vertex shaders can manipulate properties such as position, color and texture coordinate, but cannot create new vertices. The output of a vertex shader can go to a next stage in a GPU pipeline, e.g., a geometry shader or a rasterizer. Vertex shaders can enable powerful control over the details of position, movement, lighting, and color in any scene involving 3D models. Geometry shaders can generate new vertices from within the shader. For example, geometry shaders can generate new graphics primitives, such as points, lines, and triangles, from primitives that were sent to the beginning of a GPU pipeline. Tessellation shaders can act on batches of vertexes all at once to add detail, e.g., such as subdividing a model into smaller groups of triangles or other primitives at runtime, to improve things like curves and bumps, or change other attributes.

Throughout this disclosure, unless indicated otherwise, the terms “shader” and “shader program” are used interchangeably and broadly refer to a program that performs the processing for one or more graphics pipeline stages within the GPU 112. Generally, many different shaders in many different configurations are used to render an image. A group of threads may be executed for a group of vertices, primitives, or pixels. Depending upon implementation, one or more shader programs 176 can execute multiple threads in parallel, simultaneously or in an interleaved manner, and more generally, during a common time interval.

The GPU 112 can perform tasks that are used to render graphics for display on the display device 190. Some tasks may be used to render certain types of natural geographical structures or features, such as mountains, trees, lakes, and/or the like. Other tasks may be used to render man-made type structures such as houses, buildings, bridges and/or the like. Still other tasks can be used to render entities such as animals that are within and/or moving through a scene that is to be displayed. Further tasks can be used to perform lighting simulation, shadow generation, wind simulation and/or the like. Such tasks can be performed by the GPU 112 such that they are dependent on spatial and/or temporal information. For example, a task may take into account where an avatar of a user, e.g., playing a video game, is walking and looking. The task may additionally take into account a particular time of day, e.g., to determine the appropriate lighting, whether a fish should be shown as jumping out of a lake and/or whether an animal should be shown as moving through a scene, just to name a few. One or more threads can be used to service a task.

When performing tasks, the GPU 112 may issue requests for translations of virtual memory addresses to physical memory addresses. In other words, a task running on the GPU 112 may use a virtual memory address to access a page of memory, which may or may not have been written to by the GPU 112. The CPU MMU 108 or the GPU MMU 118 may receive such a request for a translation of a virtual memory address. The MMU (e.g., 108 or 118) receiving the translation request, in response thereto, utilizes its page table(s) (e.g., 164 or 174) to provide a translation of the virtual memory address to a physical memory address. More specifically, as noted above, the page table(s) (e.g., 164 or 174) include PTEs, each of which includes a physical memory address to which a virtual memory address is mapped and a valid bit. When set to 1, the valid bit indicates that contents of a page of memory located at the physical address of the PTE has already been written to by the CPU or GPU. According, when the valid bit for a PTE is set to 1, the MMU (e.g., 108 or 118) can provide a physical address to a task in response to the request for a translation of a virtual memory address, thereby enabling the task to read data from the physical address, which may enable certain graphics to be rendered. However, as noted above, when the valid bit for a PTE is set to 0, the valid bit indicates that contents of a page of memory located at the physical address of the PTE has not been written to by the CPU or GPU, in which case the MMU (e.g., 108 or 118) that performs the address translation will experience a page fault. There are various different ways that a page fault (caused by a task being performed by the GPU 112) can be handled, which are described below.

One option for handing a page fault would be for an MMU (e.g., 108 or 118) to interrupt the graphic driver 158, at which point the graphics driver 158 can halt the GPU 112. While the GPU 112 is stopped, the graphics driver 158 (or some other component of the computer system 100) can access the system disk 182 to read pre-generated graphics data from the system disk 182 and write the pre-generate graphics data to the page of memory located at the physical address mapped to the virtual address that caused the page fault. Thereafter, the GPU 112 can be restarted and the page of memory at the physical address can be accessed by the task that had been running on the GPU 112 when the page fault had occurred. However, a problem with this option is that all possible graphics data would need to pre-generated and stored on the system disk 182. This may not be practical if the amount of data to be pre-generated is larger than the disk space available on the system disk 182. Further, while this option may be possible where all the possible graphics data is static, this option would not be practical where the graphics data is dynamic, e.g., because it relies on wind and/or lighting simulations, or the like. Further, the time required to generate all of the dynamic graphics data for a large resource without regard to which pages of data are required to produce a current rendered frame could be prohibitively long.

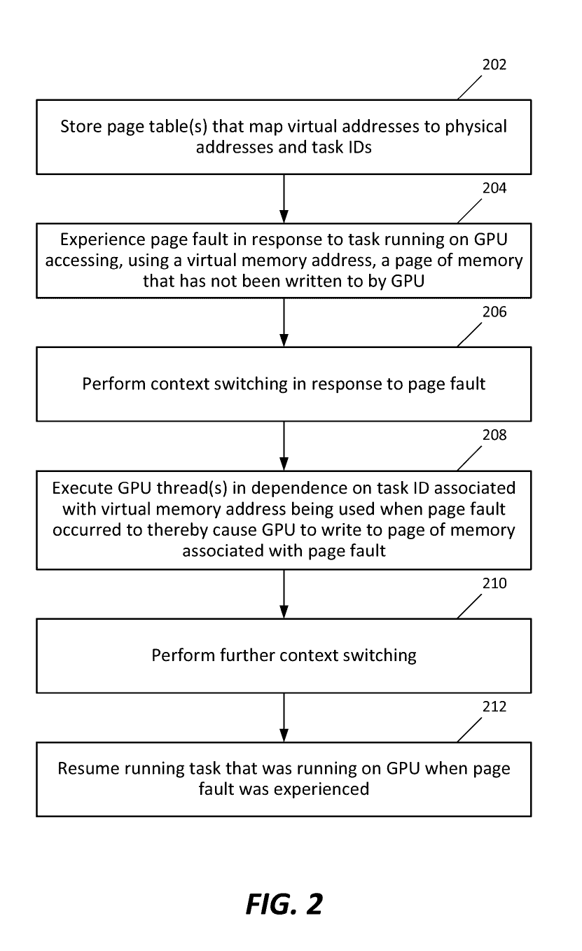

In accordance with specific embodiments of the present technology, which are initially described below with reference to FIG. 2, rather than pre-generating graphics data, graphics data is instead rendered on demand. More specifically, in accordance with certain embodiments of the present technology, graphics data is rendered in response to page faults, and thus, such embodiments can also be referred to a page fault based rendering of graphics data on demand, or more succinctly as fault based rendering of graphics data on demand.

Reference is now made to FIG. 2, which is a high level flow diagram that is used to describe methods for rendering graphics data on demand, in accordance with specific embodiments of the present technology. Such methods are for use by a system including a GPU having access to graphics memory. An example of such a system, which is also shown as including a CPU, was described above with reference to FIG. 1.

Referring to FIG. 2, step 202 involves storing one or more page tables that map virtual addresses to physical addresses and task identifiers (task IDs). More specifically, in accordance with an embodiment of the present technology, each of the page table(s) that is stored at step 202 includes a plurality of page table entries (PTEs), wherein each of the PTEs includes a physical memory address to which a virtual memory address is mapped, a valid bit, and a task ID. That task ID, as explained in more detail below, is essentially used to remedy the page fault. Explained another way, the task ID specifies the task that has write-ownership for a page of memory. The valid bit associated with each of the PTEs is either set to 1 or set to 0. Where a PTE has a valid bit that is set to 1, this indicates that contents of a page of memory located at the physical address of the PTE has been written to by a GPU (e.g., 112). Conversely, where a PTE has a valid bit that is set to 0, this indicates that contents of a page of memory located at the physical address of the PTE has not been written to by the GPU (e.g., 112).

Still referring to FIG. 2, step 204 involves experiencing a page fault when a task running on the GPU (e.g., 112) accesses a page of memory for which the valid bit, in the PTE corresponding to the page of memory, is set to 0. In other words, step 204 involves experiencing a page fault when a task running on the GPU accesses a page of memory located at the physical address of the PTE has not been written to by the GPU. Step 204 can be performed by an MMU (e.g., 118 or 108).

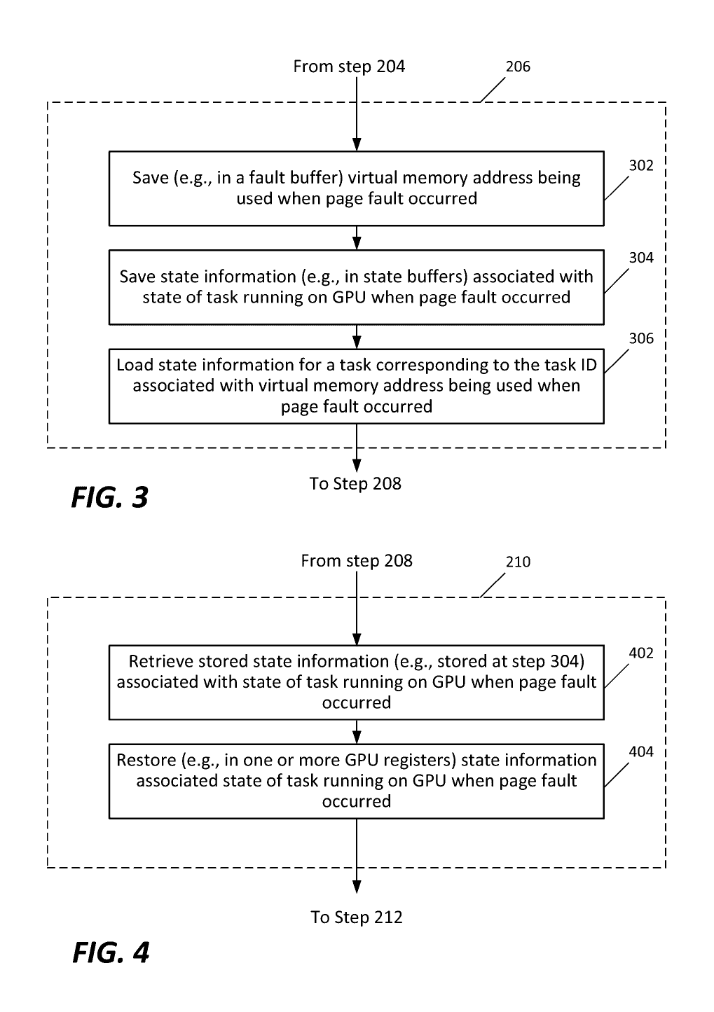

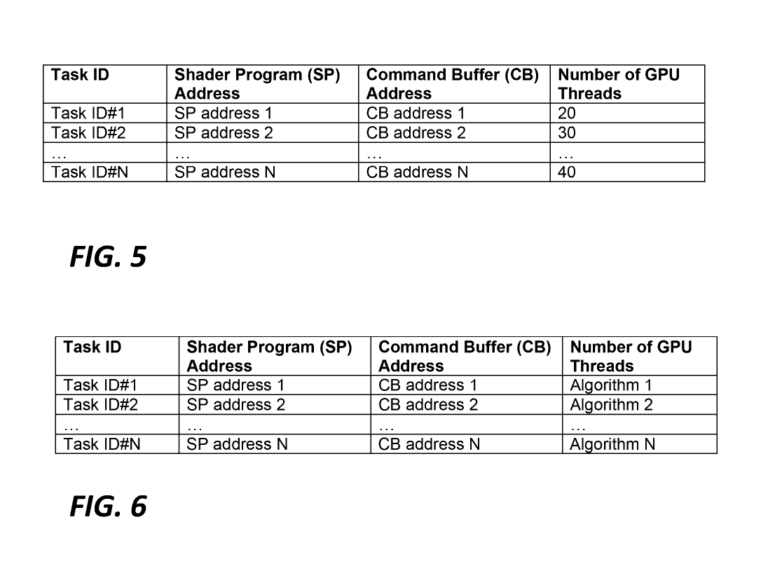

Step 206 involves performing context switching, in response to the page fault experienced at step 204. Additionally details of step 206, according to an embodiment of the present technology, are described with reference to FIG. 3. Referring briefly to FIG. 3, in accordance with an embodiment, performing context switching at step 206 includes saving the virtual memory address being used when the page fault occurred, as indicated at step 302, and saving state information associated with a state of the task running on the GPU when the page fault occurred, as indicated at step 304. Further, step 206 also involves loading (e.g., into one or more GPU registers) state information for a task corresponding to the task ID associated with the virtual memory address being used when the page fault occurred, as indicated at step 306, to enable the task to be executed. In accordance with an embodiment, at step 302 the virtual memory address that caused the page fault is saved in a fault buffer (e.g., 168). In accordance with an embodiment, at step 304, the state information, associate with the state of the task running on the GPU when the page fault occurred, is saved in a portion of system memory (e.g., 152) or in a portion of graphics memory (e.g., in the state buffers 178) that is designated for saving such state information. By performing such context switching at step 206, the GPU that experienced the page fault is freed up to perform another task and/or threads. Step 206 can be performed by a context manager (e.g., 114 or 104).

Returning to FIG. 2, step 208 involves executing one or more GPU threads in dependence on the task ID associated with the virtual memory address being used when the page fault occurred to thereby cause the GPU to write to the page of memory associated with the page fault. In accordance with an embodiment, each of the GPU threads is used to perform rendering of graphics data, such that the performing the GPU thread(s) results in the page of memory associated with the virtual address, that caused the page fault, being written to in the graphics memory, and the valid bit for the virtual address that caused the fault being set to 1. Referring briefly back to FIG. 1, depending upon implementation, the graphics driver 158, the operating system 160, the CPU fault handler 106, the GPU fault handler 116, the CPU context manager 104, or the GPU context manager 114, can be responsible for setting the valid bits in PTEs of page tables. Referring again to FIG. 2, in accordance with certain embodiments, step 208 includes identifying, based on the task ID, one or more shader programs (e.g., 176) that can be used by the GPU to write to the page of memory that caused the page fault. Such shader programs can specify which GPU threads are to be executed. The GPU threads that are executed may also cause additional memory pages (e.g., neighboring memory pages) to be written to by the GPU, in which case, the valid bits for those additional memory pages will also be set to 1.

In accordance with certain embodiments, in response to the page fault being experienced, neither the GPU (e.g., 112), nor a CPU (e.g., 102) of the system, accesses graphics data from a system disk (e.g., 182) of the system (e.g., 100). In other words, in such embodiments, the system disk need not be accessed to resolve the page fault, and more specifically, to write to the page of memory associated with the page fault. Rather, in accordance with specific embodiments, the GPU, after being freed up as a result of the context switching, performs on demand what is necessary to write to the page of memory associated with the page fault.

Step 210 involves performing further context switching to retrieve and return the state of the task that was running on the GPU when the page fault occurred. Step 210 can be performed by the same context manager (e.g., 114 or 104) that performed step 206. Additionally details of step 210, according to an embodiment of the present technology, are described with reference to FIG. 4. Referring briefly to FIG. 4, in accordance with an embodiment, performing the further context switching at step 210 includes retrieving the state information associated with the state of the task running on the GPU (e.g., at step 304) when the page fault occurred, as indicated at step 402, and restoring, in one or more GPU registers, the state information, as indicated at step 404.

Referring again to FIG. 2, step 212 involves resuming running of the task running on the GPU when the page fault was experienced at step 204. In accordance with an embodiment, step 212 includes using the virtual memory address, which was being used when the page fault was experienced, to access the page of memory associated with the page fault that was experienced at step 204. Because the page of memory has since been written to as a result of step 208, a page fault should not occur when the resumed task accesses the page of memory.

As noted above, in accordance with certain embodiments, step 208 includes identifying, based on the task ID, one or more shader programs (e.g., 176) that can be used by the GPU to write to the page of memory associated with the page fault.

In accordance with certain embodiments, step 208 includes identifying, based on the task ID associated with the virtual memory being used when the page fault occurred, which shader program address, command buffer addresses, and/or how many GPU threads to execute (e.g., simultaneously or in an interleaved manner) during a common time interval. A shader program address can be used to access a shader program, which is used to render the data needed to resolve a page fault. GPU threads can be used to execute the shader program. The GPU can use a command buffer address to fetch high level commands prepared by an application via an API (e.g., 156) for updating the GPU's state, for rendering groups of primitives, and for initiating GPU compute operations on data needed for rendering. Step 208 can be performed using one or more LUTs and/or one or more algorithms. For example, the task ID may be a number that corresponds to a row in one or more LUTs, with columns in the LUTs specifying the address of a command buffer and the address of a shader program associated with the task ID, and/or a number of GPU threads that can be executed during a common time interval. FIG. 6 illustrates an exemplary LUT that can be used to identify, based on the task ID associated with the virtual memory being used when the page fault occurred, which specific command buffer address and shader program address to use, and how many GPU threads to execute during a common time interval, to render graphics data on demand in response to a page fault.

For another example, a task ID may identify an algorithm that is to be used to specify the number of GPU threads that can be executed during a common time interval. Such an algorithm can also be used to calculate other parameters needed to be able to produce the contents of specific faulting memory pages. FIG. 6 illustrates an exemplary LUT that can be used to identify, based on the task ID associated with the virtual memory being used when the page fault occurred, which specific command buffer address and shader program address to use to write to a page of memory associated with a page fault, to render graphics data on demand, and which algorithm to use to determine how many GPU threads to execute during a common time interval. An algorithm, for example, may determine how many GPU threads to execute during a common time interval (e.g., simultaneously or in an interleaved manner) based on a distance between an avatar of a user and an object being rendered for display. In other words, distance can be a variable in an algorithm. Another exemplary variable in an algorithm, that is used to determine how many GPU threads to execute during a common time interval (e.g., simultaneously or in an interleaved manner), is an amount of time available to render graphics before the rendered graphics are to be displayed. A further exemplary variable in an algorithm, that is used to determine how many GPU threads to execute during a common time interval (e.g., simultaneously or in an interleaved manner), is a user input accepted via a user input device (e.g., 184). These are just a few examples that are not intended to be all encompassing. One reason for limiting the number of GPU threads that can be executed during a common time interval, in response to a page fault, is to limit how many compute unit of the GPUs are used to handle the page fault, so that at least some compute units of the GPU remain available to perform other GPU functions. Another reason for limiting the number of GPU threads that can be executed during a common time interval, in response to a page fault, is to limit how long it takes to perform the context switching (e.g., at steps 206 and 210) used to handle the page fault. This is because in general, the greater the number of GPU shader thread execution units in use during a common time interval for a task, the greater the amount of time required to perform context switching of that task.

A fault handler (e.g., 116 or 106) can determine how many GPU threads to execute, e.g., using one of the techniques discussed above. A delegate of the fault handler can determine which GPU threads to execute. The delegate of the fault handler can be, e.g., a customized piece of code that is provided by an application, for instance by means of a callback, instead of being included in the fault handler itself. Other variations are also possible and within the scope of embodiments of the present technology. In accordance with an embodiment, the task ID identifies a task that runs on the GPU, which determines how many GPU threads to execute and/or which GPU threads to execute to enable the GPU to write to the page of memory associated with the page fault.

Certain embodiments of the present technology, described herein, relate to methods for rendering graphics data on demand, wherein such methods are for use by a system including a GPU. In accordance with an embodiment, a method includes storing one or more page tables that map virtual memory addresses to physical memory addresses and task IDs. Additionally, the method includes experiencing a page fault in response to a task running on the GPU accessing, using a virtual memory address, a page of memory that has not been written to by the GPU. Context switching is performed in response to the page fault. One or more GPU threads are executed in dependence on the task ID associated with the virtual memory address being used when the page fault occurred to thereby cause the GPU to write to the page of memory associated with the page fault. Further context switching is performed to enable the GPU to resume running of the task that was running on the GPU when the page fault occurred. The method further includes resuming running of the task that was running on the GPU when the page fault occurred.

In accordance with an embodiment, the performing context switching in response to the page fault includes saving the virtual memory address being used when the page fault occurred and saving state information associated with a state of the task running on the GPU when the page fault occurred. Additionally, the performing context switching includes loading, into one or more GPU registers, state information for a task corresponding to the task ID associated with the virtual memory address being used when the page fault occurred. The performing further context switching includes restoring, in one or more GPU registers, the state information associated with the state of the task running on the GPU when the page fault occurred.

In accordance with an embodiment, the executing one or more GPU threads includes identifying, based on the task ID associated with the virtual memory address being used when the page fault occurred, one or more shader programs that can be used by the GPU to write to the page of memory that caused the page fault.

In accordance with an embodiment, the executing one or more GPU threads includes determining, based on the task ID associated with the virtual memory address being used when the page fault occurred, a number of GPU threads to execute during a common time interval. In certain embodiments, a look-up-table (LUT) is used to determine, based on the task ID associated with the virtual memory address being used when the page fault occurred, the number of GPU threads to execute during a common time interval. In accordance with certain embodiments, an algorithm is used to determine, based on the task ID associated with the virtual memory address being used when the page fault occurred, the number of GPU threads to execute during a common time interval.

In accordance with an embodiment, the performing one or more GPU threads includes identifying a first GPU thread, based on the task ID associated with the virtual memory being used when the page fault occurred, wherein the first GPU thread when executed uses an algorithm to determine a number of GPU threads to execute during a common time interval.

In accordance with an embodiment, the resuming running of the task running on the GPU when the page fault occurred includes using the virtual memory address, which was being used when the page fault occurred, to access the page of memory associated with the page fault.

In accordance with certain embodiments, in response to the page fault being experienced, neither the GPU, nor a CPU of the system, accesses graphics data from a disk system of the system.

A system, according to certain embodiments of the present technology, includes a GPU, a graphics memory to which the GPU has access, one or more page table, an MMU, a context manager, and a fault handler. The one or more page tables, which are stored in the graphics memory, map virtual memory addresses to physical memory addresses and task IDs. The MMU is configured to experience a page fault in response to a task running on the GPU accessing, using a virtual memory address, a page of memory that has not been written to by the GPU. The context manager is configured to perform context switching in response to the page fault to thereby save the virtual memory address being used when the page fault occurred, and state information associated with a state of the task running on the GPU when the page fault occurred. The fault handler is configured to execute one or more GPU threads in dependence on the task ID associated with the virtual memory address being used when the page fault occurred to thereby cause the GPU to write to the page of memory associated with the page fault.

In accordance with specific embodiments, after the GPU has written to the page of memory associated with the page fault, the context manager performs further context switching to retrieve the virtual memory address being used when the page fault occurred, and retrieve the state information associated with the state of the task running on the GPU when the page fault occurred. After the GPU has written to the page of memory associated with the page fault, and after the context manager performs the further context switching, the GPU resumes running of the task that had been running on the GPU when the page fault occurred. In accordance with certain embodiments, one or more of the MMU, the context manager or the fault handler are implemented by the GPU. In accordance with certain embodiments, the fault handler is configured to use a look-up-table to determine, based on the task ID, how many GPU threads are to be executed during a common time interval by the GPU to enable the GPU to write to the page of memory associated with the page fault. In accordance with certain embodiments, a delegate of the fault handler is configured to determine, based on the task ID, which GPU task is to be executed by the GPU to enable the GPU to write to the page of memory associated with the page fault and/or how many GPU threads are to be executed during a common time interval by the GPU to enable the GPU to write to the page of memory associated with the page fault. In accordance with certain embodiments, at least one of a look-up-table or an algorithm is used for the identifying, based on the task ID, which GPU task is to be executed by the GPU to enable the GPU to write to the page of memory associated with the page fault and/or how many GPU threads are to be executed during a common time interval by the GPU to enable the GPU to write to the page of memory associated with the page fault. In certain embodiments, in response to the page fault being experienced, neither the GPU, nor a CPU of the system, accesses graphics data from a disk system of the system.

A method for rendering graphics data on demand, which is for use by a system including a GPU, includes performing context switching in response to experiencing a page fault, wherein the page fault is experienced in response to a task running on the GPU accessing a page of memory that has not been written to by the GPU. The method also includes, after performing the context switching, using the GPU to write to the page of memory associated with the page fault. The method further includes, after using the GPU to write to the page of memory associated with the page fault, performing further context switching and resuming running of the task that had been running on the GPU when the page fault occurred. The performing context switching, in response to experiencing the page fault when the task running on the GPU accesses the page of memory that has not been written to by the GPU, frees up the GPU to perform one or more other tasks that enables the GPU to write to the page of memory associated with the page fault. In accordance with certain embodiments, the using the GPU to write to the page of memory associated with the page fault includes identifying a task ID that has write-ownership for the page of memory associated with the page fault, and using the task ID to identify one or more shader programs that can be used by the GPU to write to the page of memory associated with the page fault.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for rendering graphics data on demand, the method for use by a system including a graphics processing unit (GPU), the method comprising:
(a) storing one or more page tables that map virtual memory addresses to physical memory addresses and task identifiers (task IDs);
(b) experiencing a page fault in response to a task running on the GPU accessing, using a virtual memory address, a page of memory that has not been written to by the GPU;
(c) performing context switching in response to the page fault;
(d) executing one or more GPU threads in dependence on the task ID associated with the virtual memory address being used when the page fault occurred to thereby cause the GPU to write to the page of memory associated with the page fault;
(e) performing further context switching to enable the GPU to resume running of the task that was running on the GPU when the page fault occurred; and
(f) resuming running of the task that was running on the GPU when the page fault occurred.

2. The method of claim 1, wherein:
the (c) performing context switching in response to the page fault includes
saving the virtual memory address being used when the page fault occurred;
saving state information associated with a state of the task running on the GPU when the page fault occurred; and
loading, into one or more GPU registers, state information for a task corresponding to the task ID associated with the virtual memory address being used when the page fault occurred; and
the (e) performing further context switching includes
restoring, in one or more GPU registers, the state information associated with the state of the task running on the GPU when the page fault occurred.

3. The method of claim 1, wherein the (d) executing one or more GPU threads includes identifying, based on the task ID associated with the virtual memory address being used when the page fault occurred, one or more shader programs that can be used by the GPU to write to the page of memory that caused the page fault.

4. The method of claim 1, wherein the (d) executing one or more GPU threads includes determining, based on the task ID associated with the virtual memory address being used when the page fault occurred, a number of GPU threads to execute during a common time interval.

5. The method of claim 4, wherein a look-up-table (LUT) is used for the determining, based on the task ID associated with the virtual memory address being used when the page fault occurred, the number of GPU threads to execute during a common time interval.

6. The method of claim 4, wherein an algorithm is used for the determining, based on the task ID associated with the virtual memory address being used when the page fault occurred, the number of GPU threads to execute during a common time interval.

7. The method of claim 1, wherein the (d) performing one or more GPU threads includes identifying a first GPU thread, based on the task ID associated with the virtual memory being used when the page fault occurred, wherein the first GPU thread when executed uses an algorithm to determine a number of GPU threads to execute during a common time interval.

8. The method of claim 1, wherein the (f) resuming running of the task running on the GPU when the page fault occurred includes using the virtual memory address, which was being used when the page fault occurred, to access the page of memory associated with the page fault.

9. The method of claim 1, wherein in response to the page fault being experienced, neither the GPU, nor a CPU of the system, accesses graphics data from a disk system of the system.

10. The method of claim 1, wherein:
each of the one or more page tables includes a plurality of page table entries (PTEs);
each of the PTEs includes a physical memory address to which a virtual memory address is mapped, a valid bit, and a task ID;
the valid bit included in each of the PTEs is either set to 1 or set to 0, which indicates, respectively, that contents of a page of memory located at the physical memory address of the PTE has, or has not, been written to by the GPU;
the (b) experiencing the page fault occurs in response to a task running on the GPU accessing, using a virtual memory address, a page of memory associated with a PTE having a valid bit set to 0; and
the (d) executing the one or more GPU threads to thereby cause the GPU to write to the page of memory, associated with the page fault, results in the valid bit in the PTE associated with the page of memory being changed from being set to 0 to being set to 1.

11. A system, comprising:
a graphics processing unit (GPU);
a graphics memory to which the GPU has access;
one or more page tables, stored in the graphics memory, that map virtual memory addresses to physical memory addresses and task identifiers (task IDs);
a memory management unit (MMU) configured to experience a page fault in response to a task running on the GPU accessing, using a virtual memory address, a page of memory that has not been written to by the GPU;
a context manager configured to perform context switching in response to the page fault to thereby save
the virtual memory address being used when the page fault occurred, and
state information associated with a state of the task running on the GPU when the page fault occurred; and
a fault handler configured to execute one or more GPU threads in dependence on the task ID associated with the virtual memory address being used when the page fault occurred to thereby cause the GPU to write to the page of memory associated with the page fault.

12. The system of claim 11, wherein:
the context manager is configured to perform further context switching, after the GPU has written to the page of memory associated with the page fault, to thereby retrieve the virtual memory address being used when the page fault occurred, and retrieve the state information associated with the state of the task running on the GPU when the page fault occurred; and
the GPU is configured to resume running of the task that had been running on the GPU when the page fault occurred, after the GPU has written to the page of memory associated with the page fault, and after the context manager performs the further context switching.

13. The system of claim 11, wherein one or more of the MMU, the context manager or the fault handler are implemented by the GPU.

14. The system of claim 11, wherein the fault handler is configured to use a look-up-table to determine, based on the task ID, how many GPU threads are to be executed during a common time interval by the GPU to enable the GPU to write to the page of memory associated with the page fault.

15. The system of claim 11, wherein a delegate of the fault handler is configured to determine, based on the task ID, at least one of:
which GPU task is to be executed by the GPU to enable the GPU to write to the page of memory associated with the page fault; or
how many GPU threads are to be executed during a common time interval by the GPU to enable the GPU to write to the page of memory associated with the page fault.

16. The system of claim 11, wherein at least one of a look-up-table or an algorithm is used for the identifying, based on the task ID, at least one of:
which GPU task is to be executed by the GPU to enable the GPU to write to the page of memory associated with the page fault; or
how many GPU threads are to be executed during a common time interval by the GPU to enable the GPU to write to the page of memory associated with the page fault.

17. The system of claim 11, wherein in response to the page fault being experienced, neither the GPU, nor a CPU of the system, accesses graphics data from a disk system of the system.

18. A method for rendering graphics data on demand, the method for use by a system including a graphics processing unit (GPU), the method comprising:
performing context switching in response to experiencing a page fault, wherein the page fault is experienced in response to a task running on the GPU accessing a page of memory that has not been written to by the GPU;
after performing the context switching, using the GPU to write to the page of memory associated with the page fault; and
after using the GPU to write to the page of memory associated with the page fault, performing further context switching and resuming running of the task that had been running on the GPU when the page fault occurred.

19. The method of claim 18, wherein the performing context switching, in response to experiencing the page fault, frees up the GPU to perform one or more other tasks that enables the GPU to write to the page of memory associated with the page fault.

20. The method of claim 18, wherein the using the GPU to write to the page of memory associated with the page fault includes identifying a task ID that has write-ownership for the page of memory associated with the page fault, and using the task ID to identify one or more shader programs that can be used by the GPU to write to the page of memory associated with the page fault.
